(19) United States
(12) Patent Application Publication
(10) Pub. No.: US 2005/0049364 A1
(43) Pub. Date: Mar. 3, 2005

(54) Process for producing resin composition, modifier for polyester resin, and process for producing modified polyester resin

(75) Inventors: Takashi Sanada, Ichihara-shi (JP); Mitsuyoshi Shimano, Ichihara-shi (JP); Manabu Ishikawa, Ichihara-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Sumitomo Chemical Company, Limited

(21) Appl. No.: 10/913,190

(22) Filed: Aug. 6, 2004

(30) Foreign Application Priority Data
Aug. 28, 2003 (JP) 2003-209254

(51) Int. Cl. C08L 51/00

(52) U.S. Cl. 525/191

(57) ABSTRACT

There are provided: (I) a process for producing a resin composition comprising the step of melt kneading at least (i) an epoxy group-containing polyolefin resin, (ii) an epoxy resin, and (iii) optionally, an ethylene-α-olefin copolymer; (II) a modifier for a polyester resin comprising a resin composition produced according to the above-mentioned process; and (III) a process for producing a modified polyester resin comprising the step of melt kneading at least (1) a resin composition produced according to the above-mentioned process, and (2) a polyester resin.

### FIELD OF THE INVENTION

The present invention relates to (1) a process for producing a resin composition, (2) a modifier for a polyester resin, and (3) a process for producing a modified polyester resin.

### BACKGROUND OF THE INVENTION

In order to improve impact strength of a polyester resin, there are known:

(1) a method of melt kneading (i) a polyester resin and (ii) an epoxy group-containing polyolefin (JP 52-32045A),

(2) a method of melt kneading (i) a polyalkylene terephtalate, (ii) a copolymer of ethylene, an α-olefin and a glycidyl ester of an α,β-unsaturated acid and (iii) an epoxy compound (JP 55-137154A), and

(3) a method of melt kneading (i) an aromatic polyester, (ii) a copolymer of an α-olefin and a glycidyl ester of an α, β-unsaturated acid and (iii) an ethylene copolymer of ethylene and an α-olefin having three or more carbon atoms (JP 58-17148A, corresponding to U.S. Pat. No. 4,461,871).

### SUMMARY OF THE INVENTION

However, the above-mentioned methods have a problem in that an appearance and physical properties of a molded article comprising a melt-kneaded product produced according to the above-mentioned methods are often deteriorated by a crosslinked by-product produced in an excessive reaction between a terminal carboxyl group contained in a polyester resin and an epoxy group, or an excessive reaction between epoxy groups.

An object of the present invention is to provide (1) a process for producing a modified polyester resin having an excellent appearance, impact strength and a hydrolysis resistance, (2) a modifier for a polyester resin used for said process, and (3) a process for producing a resin composition suitable for said modifier.

The present inventors have undertaken extensive studies to modify a polyester resin, and as a result, have found (1) that a resin composition produced by melt kneading an epoxy group-containing polyolefin resin and an epoxy resin is suitable for a modifier for a polyester resin, and (2) that a resin composition produced by melt kneading an epoxy group-containing polyolefin resin, an epoxy resin and an ethylene-α-olefin copolymer, which copolymer has (i) an affinity for said epoxy group-containing polyolefin resin, and (ii) a glass transition temperature lower than that of said epoxy group-containing polyolefin resin, is also suitable for a modifier for a polyester resin, and thereby the present invention has been accomplished.

The present invention is a process for producing a resin composition, which comprises the step of melt kneading at least:

(1) from 10 to 99% by weight of an epoxy group-containing polyolefin resin, and

(2) from 1 to 90% by weight of an epoxy resin,

wherein the total of both components is 100% by weight. This process is hereinafter referred to as “process-1”.

Also, the present invention is a process for producing a resin composition, which comprises the step of melt kneading at least:

(1) from 5 to 98% by weight of an epoxy group-containing polyolefin resin,

(2) from 1 to 50% by weight of an epoxy resin, and

(3) from 1 to 94% by weight of an ethylene-α-olefin copolymer,

wherein the total of those three components is 100% by weight. This process is hereinafter referred to as “process-2”.

Further, the present invention is a modifier for a polyester resin, which comprises a resin composition produced according to the above-mentioned process-1 or 2.

Still further, the present invention is a process for producing a modified polyester resin, which comprises the step of melt kneading at least:

(1) a resin composition produced according to the above-mentioned process-1 or 2, and

(2) a polyester resin.

### DETAILED DESCRIPTION OF THE INVENTION

The epoxy group-containing polyolefin resin used in the present invention means (i) a resin produced by grafting an addition polymerizable monomer containing an epoxy group (hereinafter, referred to as “epoxy group-containing monomer”) onto a polyolefin, or (ii) a copolymer resin produced by copolymerizing the epoxy group-containing monomer with an olefin.

As a method of the above-mentioned grafting, there are exemplified:

(1) a method comprising the step of mixing under heating (a) the polyolefin, (b) the epoxy group-containing monomer and (c) a radical initiator in a solution or suspension state in a solvent such as an aromatic hydrocarbon (for example, xylene and toluene) and an aliphatic hydrocarbon (for example, hexane and heptane), and

(2) a method comprising the steps of (i) mixing (a) the polyolefin, (b) the epoxy group-containing monomer and (c) a radical initiator under a condition that the radical initiator is not substantially decomposed, thereby producing a mixture, and then (ii) melt mixing said mixture in a kneading machine such as an extruder, a Banbury mixer and a kneader generally used in a synthetic resin field.

In the above-mentioned method (2), a melt mixing temperature in the step (ii) is suitably determined depending upon, for example, a degradation temperature of the polyolefin, a decomposition temperature of the epoxy group-containing monomer, and a decomposition temperature of the radical initiator; and it is generally from 80 to 350° C., and preferably from 100 to 300° C.

Examples of the above-mentioned epoxy group-containing monomer are an unsaturated glycidyl ester represented by the following formula (1), and an unsaturated glycidyl ether represented by the following formula (2), 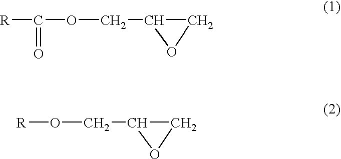
wherein R is a carbon-carbon double bond-containing hydrocarbon group having from 2 to 8 carbon atoms such as a vinyl group and an ally group.

Examples of the compounds represented by the above formulas are glycidyl acrylate, glycidyl methacrylate, and allyl glycidyl ether.

The above-mentioned radical initiator has a decomposition temperature of generally 80° C. or more, at which temperature a half-life thereof is 1 minute. A representative example of the radical initiator used in the above-mentioned method (2) is an organic peroxide such as dicumylperoxide, benzoylperoxide, di-t-butylperoxide and 2,5-dimethyl-2,5-di(t-butylperoxy)hexane. Representative examples of the radical initiator used for a graft reaction in a suspension state in the above-mentioned method (1) are an organic peroxide such as benzoylperoxide, lauroylperoxide, t-butyl peroxypivalate, t-butyl hydroperoxide, and dicumylperoxide; and an azo-compound such as azobisisobutyronitrile and azobisdimethylvaleronitrile. Examples of a surfactant used for a graft reaction in said suspension state are polyvinyl alcohol, cellulose, acrylic acid, an inorganic salt and an alkylene oxide.

In the above-mentioned graft reaction, the epoxy group-containing monomer is used in an amount of generally from 0.1 to 20 parts by weight per 100 parts by weight of the polyolefin. When said amount is less than 0.1 part by weight, the produced resin composition may not have a modifying effect sufficiently on properties of the polyester resin. When said amount is more than 20 parts by weight, a homopolymerization reaction of the epoxy group-containing monomer may have a priority over said graft reaction.

In the above-mentioned graft reaction, the radical initiator is used in an amount of generally from 0.001 to 5 parts by weight per 100 parts by weight of the polyolefin. When said amount is less than 0.001 part by weight, the graft reaction may not proceed sufficiently. When said amount is more than 5 parts by weight, a decomposition reaction and/or a crosslinking reaction of the polyolefin may proceed remarkably.

The above-mentioned copolymerization reaction of the epoxy group-containing monomer with the olefin is carried out preferably in production facilities for a high pressure produced-low density polyethylene. Generally, a content of a unit of the epoxy group-containing monomer contained in the produced copolymer is preferably from 0.2 to 20% by mol, and particularly preferably from 0.5 to 15% by mol, wherein the total of said unit and a unit of the olefin contained in said copolymer is 100% by mol; and a content of a unit of the epoxy group-containing monomer contained in the epoxy group-containing polyolefin resin produced by the above-mentioned graft reaction is generally from 0.1 to 20% by weight, wherein the total of said unit and a unit of the olefin contained in the epoxy group-containing polyolefin resin is 100% by mol. In the present invention, the term “unit” means a polymerized monomer unit. Each of the epoxy group-containing monomer and the olefin may be used in combination with other comonomer such as an unsaturated carboxylic acid ester and a vinyl ester.

Examples of the above-mentioned unsaturated carboxylic acid ester are an alkyl acrylate, an alkyl methacrylate, an alkoxy acrylate and an alkoxy methacrylate. Each of the alkyl acrylate and the alkyl methacrylate generally has preferably from 3 to 30 carbon atoms, and particularly preferably form 4 to 20 carbon atoms. Examples of the alkyl acrylate and the alkyl methacrylate are methyl acrylate, ethyl acrylate, butyl acrylate, 2-ethylhexyl acrylate and methyl methacrylate. Each of the alkoxy acrylate and the alkoxy methacrylate generally has preferably form 4 to 35 carbon atoms, and particularly preferably form 4 to 20 carbon atoms. Examples of the alkoxy acrylate and the alkoxy methacrylate are methoxy acrylate, ethoxy acrylate, butoxy acrylate and methoxy methacrylate.

The above-mentioned vinyl ester generally has 20 or less carbon atoms, and preferably form 4 to 16 carbon atoms. Examples of the vinyl ester are vinyl acetate, vinyl propionate and vinyl butyrate. Among them, vinyl acetate is particularly preferable.

A specific example of a method for producing the above-mentioned copolymer of the epoxy group-containing monomer with the olefin is a method comprising the step of copolymerizing (i) ethylene, (ii) a compound represented by the above formula (1) or (2), and optionally (iii) one or more monomers selected from the group consisting of an α-olefin, the above-mentioned unsaturated carboxylic acid ester and the above-mentioned vinyl ester in the presence of a radical initiator at from 100 to 300° C. and from 50 to 400 MPa, in the presence or absence of a solvent and a chain transfer agent.

The epoxy resin used in the present invention means a resin containing 2 or more epoxy groups on the average in its molecule, which resin excludes the above-mentioned epoxy group-containing polyolefin resin. A preferable epoxy resin is a glycidy ether-type epoxy resin, a glycidy ester-type epoxy resin, a glycidy amine-type epoxy resin or an alicyclic-type epoxy resin in order to obtain sufficient effects of the present invention.

The above-mentioned glycidy ether-type epoxy resin is a resin containing a glycidyl ether group, and can be produced by a reaction of epichlorohydrine with phenols and/or alcohols in the presence of a strong alkali. Examples of the glycidy ether-type epoxy resin are a bisphenol A-type epoxy resin, a bisphenol F-type epoxy resin, a bisphenyl-type epoxy resin, a phenol novolak-type epoxy resin, an o-cresol novolak-type epoxy resin, a trishydroxyphenylmethane-type epoxy resin and a tetraphenylethane-type epoxy resin, those epoxy resins corresponding to kinds of phenols and/or alcohols used, respectively. A further example of the epoxy resin is an epoxy resin produced by a reaction of epichlorohydrine with dihydric phenols such as hydroquinone and resorcine in the presence of a strong alkali. Examples of a trade name of a commercially available bisphenol A-type epoxy resin are EPIKOTE 828, EPIKOTE 825 and EPIKOTE 1001, all of which are manufactured by Japan Epoxy Resins Co., Ltd.; EPOMIK R-140P and EPOMIK R-304, all of which are manufactured by Mitsui Chemicals, Inc.; EPICLON 855 manufactured by Dainippon Ink & Chemicals, Inc.; and DER 331 manufactured by Dow Chemical.

The above-mentioned glycidy ester-type epoxy resin can be produced by a reaction of epichlorohydrine with a carbonyl group of a phthalic acid derivative or a synthetic aliphatic acid. Examples of the glycidy ester-type epoxy resin are those derived from an aromatic carboxylic acid such as p-hydroxybenzoic acid, m-hydroxybenzoic acid, terephthalic acid and isophthalic acid.

The above-mentioned glycidy amine-type epoxy resin can be produced by a reaction of epichlorohydrine with primary amines or secondary amines. An example of the glycidy amine-type epoxy resin is an aromatic amine-based epoxy resin derived from a p-aminophenol, m-aminophenol, 4,4′-diaminodiphenylmethane, p-phenylenediamine, m-phenylenediamine or m-xylylenediamine.

The above-mentioned alicyclic-type epoxy resin can be produced by a process comprising the steps of (1) oxidizing a corresponding compound having a carbon-carbon double bond with a peroxide such as peracetic acid, and (2) epoxidizing.

The ethylene-α-olefin copolymer in the present invention is used in order to improve impact strength of a resin composition produced by the process according to the present invention, and has a glass transition temperature lower than that of the above-mentioned epoxy group-containing polyolefin resin. Examples of the α-olefin in said ethylene-α-olefin copolymer are propylene, 1-butene, 1-pentene, 4-methylpentene-1, isobutylene, 1-hexene, 1-octene, 1-nonene, 1-decene, 1-undecene and 1-dodecene. Among them, preferred is propylene, 1-butene, 1-hexene or 1-octene. Each of ethylene and the α-olefin used for producing the ethylene-α-olefin copolymer may be combined with a non-conjugated diene. Examples of the non-conjugated diene are 5-ethylidene-2-norbornene, 5-(1′-propenyl)-2-norbornene, dicyclopentadiene and 1,4-hexadiene. Said ethylene-α-olefin copolymer may be used in combination with a partially hydrogenated styrene-butadiene-styrene block copolymer rubber, a partially hydrogenated styrene-isoprene block copolymer rubber or a mixture thereof, each of these two rubbers having a similar structure to that of the ethylene-α-olefin copolymer.

A blending ratio of the epoxy group-containing polyolefin resin in the process-1 according to the present invention is from 10 to 99% by weight, and that of the epoxy resin therein is from 1 to 90% by weight, wherein the total of both components is 100% by weight.

A blending ratio of the epoxy group-containing polyolefin resin, the epoxy resin and the ethylene-α-olefin copolymer (namely, epoxy group-containing polyolefin resin/epoxy resin/ethylene-α-olefin copolymer) in the process-2 according to the present invention is 5 to 98% by weight/1 to 50% by weight/1 to 94% by weight, and preferably 5 to 90% by weight/1 to 50% by weight/9 to 94% by weight, wherein the total of those three components is 100% by weight.

Examples of a method for melt kneading in the present invention are a batchwise method and a continuous method, and the latter method is more advantageous than the former method from an economical point of view. Examples of a kneader used for the batchwise method are a Banbury mixer and a labo-plastomil, and examples of a kneader used for the continuous method are a single screw extruder and a double screw extruder. A kneading temperature is the same as or higher than a temperature, at which all the starting components melt, and preferably from 150 to 300° C. When the kneading temperature is 350° C. or higher, the starting components may be deteriorated.

The polyester resin used in the present invention means a polymer or a copolymer produced by a condensation reaction of two main compounds, namely, by a condensation reaction of a dicarboxylic acid or its ester-formable derivative and a diol or its ester-formable derivative. The polyester resin may be a commercially available polyester resin. From an industrial point of view, the polyester resin is preferably an aromatic polyester resin. The polyester resin used in the present invention also means a linear polymer such as a polycarbonare containing a carbonic ester bond (—O—R—OCO—) in its main polymer chain. From an industrial point of view, a polycarbonate is preferably an aromatic polycarbonate.

The above-mentioned aromatic polyester resin means a polyester resin containing an aromatic ring in its chain units. The aromatic polyester resin can be produced by a condensation reaction of two main compounds, namely, by a condensation reaction of an aromatic dicarboxylic acid or its ester-formable derivative and a diol or its ester-formable derivative.

Examples of the aromatic dicarboxylic acid and its ester-formable derivative are terephthalic acid, isophthalic acid, phthalic acid, 2,6-naphthalenedicarboxylic acid, 1,5-naphthalenedicarboxylic acid, bis(p-carboxyphenyl )methane, anthracenedicarboxylic acid, 4,4′-diphenyldicarboxylic acid and 4,4′-diphenyl ether dicarboxylic acid, and their ester-formable derivatives.

Each of the aromatic dicarboxylic acid and its ester-formable derivative may be combined with 40% by mol or less of other dicarboxylic acid or its ester-formable derivative, wherein the total of said combination is 100% by mol. Examples of said other dicarboxylic acid are an aliphatic dicarboxylic acid such as adipic acid, sebacic acid, azelaic acid and dodecanedioic acid; and an alicyclic dicarboxylic acid such as 1,3-cyclohexanedicarboxylic acid and 1,4-cyclohexanedicarboxylic acid.

Examples of the above-mentioned diol are an aliphatic diol having from 2 to 10 carbon atoms such as ethylene glycol, propylene glycol, 1,4-butanediol, neopentyl glycol, 1,5-pentanediol, 1,6-hexanediol, decamethylene glycol and cyclohexanediol, and a combination of two or more thereof; and a long-chain glycol having a molecular weight of from 400 to 6000 such as polyethylene glycol, poly-1,3-propylene glycol and polytetramethylene glycol, and a combination of two or more thereof.

Examples of a preferable aromatic polyester are polyethylene terephthalate, polypropylene terephthalate, polybutylene terephthalate, polyhexamethylene terephthalate, polycyclohexylenedimethylene terephthalate and polyethylene 2,6-naphthalate.

An example of the above-mentioned aromatic polycarbonate is an aromatic polycarbonate produced by a reaction of phosgene with a 4,4′-dihydroxydiarylalkane such as 4,4′-dihydroxydiphenyl-2,2′-propane (generally referred to as bisphenol-A). Among them, particularly preferred is an aromatic polycarbonate produced by a reaction of phosgene with 4,4′-dihydroxydiphenyl-2,2′-propane. Examples of a process for producing the aromatic polycarbonate are (i) a phosgene process comprising the step of reacting phosgene with 4,4′-dihydroxydiphenyl-2,2′-propane in the presence of a caustic alkali (alkali hydroxide) aqueous solution and a solvent, and (ii) a transesterification process comprising the step of transesterifying a carbonic diester with 4,4′-dihydroxydiphenyl-2,2′-propane in the presence of a catalyst.

Each of the starting components used in the present invention may be combined with additives such as fire retardants, plasticizers, antioxidants and weatherability stabilizers. Particularly, when combining each of them with additives known as additives for the epoxy group-containing polyolefin resin, the epoxy resin, the ethylene-α-olefin copolymer or the polyester resin, the produced resin composition or the produced modified polyester rein may be further improved in its physical properties.

A melt kneading method in the processes-1 and 2 according to the present invention is not limited. Examples thereof are (1) a method comprising the step of melt kneading all the components in a lump, (2) a method comprising the steps of (i) melt kneading some of all the components and others thereof separately to obtain respective melt kneaded products, and then, (ii) melt kneading the respective melt kneaded products with each other, and (3) a method comprising the step of melt kneading the components in an extruder, wherein the components are fed to respective feeding inlets of the extruder.

Examples of a melt kneading method in the process for producing a modified polyester resin according to the present invention are (1) a method comprising the step of melt kneading a resin composition produced by the process-1 or 2 according to the present invention with the polyester resin, and (2) a method comprising the step of melt kneading continuously, in an extruder, the starting components used in the process-1 or 2 according to the present invention with the polyester resin, wherein the starting components are fed to an upper inlet of the extruder, and the polyester resin is fed to a lower inlet thereof.

The step of melt kneading the resin composition produced by the process-1 or 2 according to the present invention with the polyester resin may be combined with a step constituting an injection molding process or an extrusion molding process. A preferable embodiment in said combination comprises the steps of (1) melt kneading said resin composition with a small amount of the polyester resin to produce a master batch, (2) mixing the master batch with the remaining amount of the polyester resin to obtain a mixture, (3) drying the mixture in order to eliminate water mainly contained in the polyester resin, (4) melt kneading the dried mixture to produce a modified polyester resin, and (5) injection molding or extrusion molding the modified polyester resin. It is generally preferable to use the above-mentioned master batch in order to prevent the resin composition from adhering to one other in the above step (3).

The modified polyester resin produced by the process according to the present invention can easily be molded by a general resin-molding method such as an injection molding method, an extrusion molding method and a blow molding method.

Each of the resin composition and the modified polyester resin produced by the process according to the present invention is excellent in its performance such as an impact resistance, a hydrolysis resistance and moldability, and therefore, they can widely be used in an industrial field such as cars and home electric instruments.

### EXAMPLE

The present invention is explained with reference to the following Examples, which do not limit the scope of the present invention. The following starting components were used.

1. Epoxy Group-Containing Polyolefin Resin

There was used a pellet of an epoxy group-containing polyolefin resin having a trade name of BONDFAST E manufactured by Sumitomo Chemical Company, Limited, which resin (1) has a melt index of 10 g/10 minutes measured at 190° C. under a load of 2.16 kg, (2) is an ethylene-glycidyl methacrylate copolymer, and (3) contains an ethylene unit of 88% by weight and a glycidyl methacrylate unit of 12% by weight, wherein the total of both units is 100% by weight.

2. Epoxy Resin

There was used an o-cresol novolak-type epoxy resin manufactured by Sumitomo Chemical Company, Limited, which has (1) a trade name of SUMIEPOXY ESCN220HH, (2) an epoxy equivalent of from 200 to 230 g/eq, (3) a softening point of 84° C. or higher, and (4) a viscosity of 18 poise at 150° C.

3. Ethylene-α-Olefin Copolymer

There was used a pellet of an ethylene-hexene copolymer manufactured by Sumitomo Chemical Company, Limited, which copolymer has (1) a trade name of EXCELLEN FX CX5015, (2) density of 0.870 g/cm³, and (3) a melt index of 12 g/10 minutes at 190° C.

4. Polyester Resin

There was used a pellet of polyethylene terephthalate manufactured by Kanebo Ltd., which has (1) a trade name of EFG00, (2) a terminal acid value of 25 mg-equivalent/kg, and (3) an intrinsic viscosity of 0.54.

### Example 1

The epoxy group-containing polyolefin resin, the epoxy resin and the ethylene-α-olefin copolymer were melt kneaded in a double screw kneading extruder (cylinder temperature of 200° C.) having a trade name of TEM 50 manufactured by Toshiba Machine Co., Ltd. by feeding them in a lump in a ratio (part by weight) shown in Table 1 to an upper feeding inlet of the double screw kneading extruder. The obtained melt kneaded product, which was extruded out of dies of the double screw kneading extruder, was cooled in a water bath, and then, was pelletized with a strand cutter, thereby obtaining a pellet of a resin composition.

### Example 2

Example 1 was repeated except that 10 parts by weight of the epoxy resin was changed to 20 parts by weight thereof, thereby obtaining a pellet of a resin composition.

### Comparative Example 1

Example 1 was repeated except that the epoxy resin was not used, thereby obtaining a pellet of a resin composition.

### Comparative Example 2

The epoxy group-containing polyolefin resin and the ethylene-α-olefin copolymer were blended, thereby obtaining a mixture.

### Example 3

Fifty (50) parts by weight of the pellet of a resin composition obtained in Example 1 and 50 parts by weight of the polyester resin were melt kneaded at 260° C. and 80 rpm in a 20 mm φ-double screw kneader manufactured by Toyo Seiki Co., Ltd., thereby obtaining a pellet of a master batch.

Ten (10) parts by weight of said pellet of a master batch and 90 parts by weight of the polyester resin were blended to obtain a mixture.

Said mixture was injection molded at a cylinder temperature of 270° C. and a mold temperature of 50° C. with an injection molding machine having a trade name of IS 1000E manufactured by Toshiba Machine Co., Ltd., thereby obtaining a pellet.

Said pellet was dipped in hot water (100° C.) for 96 hours, and its hydrolysis resistance was evaluated based on a difference between its melt index before said dipping and its melt index thereafter, wherein the melt index (dg/min.) was measured at 260° C. under a load of 49 N using a pellet vacuum dried at 120° C. for 8 hours. The larger the difference is, the smaller the hydrolysis resistance is.

There was evaluated an appearance of a sheet made from the injection-molded pellet mentioned above. Results are summarized in Table 2.

### Example 4

Example 3 was repeated except that the resin composition pellet obtained in Example 1 was changed to the resin composition pellet obtained in Example 2. Results are summarized in Table 2.

### Comparative Example 3

Example 3 was repeated except that the resin composition pellet obtained in Example 1 was changed to the resin composition pellet obtained in Comparative Example 1. Results are summarized in Table 2.

### Comparative Example 4

Example 3 was repeated except that the resin composition pellet obtained in Example 1 was changed to the resin composition pellet obtained in Comparative Example 2. Results are summarized in Table 2.

TABLE 1

| | Example | | Comparative Example | |
|---|---|---|---|---|
| | 1 | 2 | 1 | 2 |
| Kneading ratio | | | | |
| BONDFAST E | 40 | 40 | 40 | 40 |
| SUMIEPOXY ESCN220HH | 10 | 20 | — | — |
| EXCELLEN FX CX5015 | 60 | 60 | 60 | 60 |

TABLE 2

| | Example | | Comparative Example | |
|---|---|---|---|---|
| | 3 | 4 | 3 | 4 |
| Blending for master batch | | | | |
| Resin composition (Note) | 50 | 50 | 50 | 50 |
| Polyester resin | 50 | 50 | 50 | 50 |
| Blending for modified | | | | |
| polyester resin | | | | |
| Master batch mentioned above | 10 | 10 | 10 | 10 |
| Polyester resin | 90 | 90 | 90 | 90 |
| Evaluation | | | | |
| Melt index before dipping (1) | 44 | 52 | 60 | 44 |
| Melt index after dipping (2) | 30 | 33 | 48 | 102 |
| \| (1) − (2) \| | 14 | 19 | 12 | 58 |
| Appearance of sheet | Good | Good | Very bad | Very bad |

Note

The resin compositions used in Examples 3 and 4, and Comparative Examples 3 and 4 were those obtained in Examples 1 and 2, and Comparative Examples 1 and 2, respectively.

1. A process for producing a resin composition, which comprises the step of melt kneading at least:
(1) from 10 to 99% by weight of an epoxy group-containing polyolefin resin, and
(2) from 1 to 90% by weight of an epoxy resin, wherein the total of both components is 100% by weight.

2. The process for producing a resin composition according to claim 1, wherein the epoxy group-containing polyolefin resin is a copolymer containing a unit of ethylene and a unit of a glycidyl ester of an unsaturated carboxylic acid, or a copolymer containing a unit of ethylene and a unit of a glycidyl ether having an unsaturated group.

3. The process for producing a resin composition according to claim 2, wherein the unit of ethylene is contained in an amount of from 50 to 99.9% by weight, and the unit of a glycidyl ester of an unsaturated carboxylic acid or the unit of a glycidyl ether having an unsaturated group is from 0.1 to 50% by weight, wherein the total of both units is 100% by weight.

4. A process for producing a resin composition, which comprises the step of melt kneading at least:
(1) from 5 to 98% by weight of an epoxy group-containing polyolefin resin,
(2) from 1 to 50% by weight of an epoxy resin, and
(3) from 1 to 94% by weight of an ethylene-α-olefin copolymer,
wherein the total of those three components is 100% by weight.

5. The process for producing a resin composition according to claim 4, wherein the epoxy group-containing polyolefin resin is a copolymer containing a unit of ethylene and a unit of a glycidyl ester of an unsaturated carboxylic acid, or a copolymer containing a unit of ethylene and a unit of a glycidyl ether having an unsaturated group.

6. The process for producing a resin composition according to claim 5, wherein the unit of ethylene is contained in an amount of from 50 to 99.9% by weight, and the unit of a glycidyl ester of an unsaturated carboxylic acid or the unit of a glycidyl ether having an unsaturated group is from 0.1 to 50% by weight, wherein the total of both units is 100% by weight.

7. A modifier for a polyester resin, which comprises a resin composition produced by the process according to claim 1.

8. A modifier for a polyester resin, which comprises a resin composition produced by the process according to claim 4.

9. A process for producing a modified polyester resin, which comprises the step of melt kneading at least:
(1) a resin composition produced by the process according to claim 1, and
(2) a polyester resin.

10. A process for producing a modified polyester resin, which comprises the step of melt kneading at least:
(1) a resin composition produced by the process according to claim 4, and
(2) a polyester resin.
